(19) United States
(12) Patent Application Publication
(10) Pub. No.: US 2017/0367066 A1
(43) Pub. Date: Dec. 21, 2017

(54) TERRESTRIAL TRANSCEIVER-BASED POSITIONING DATA DOWNLOAD FOR SEMI-CONNECTED DEVICES

(71) Applicant: QUALCOMM Incorporated, San Diego, CA (US)

(72) Inventors: Ashok Bhatia, San Diego, CA (US); Neethu Joseph, San Diego, CA (US); Wei Chen, San Diego, CA (US); Meghna Agrawal, Sunnyvale, CA (US); Chandrakant Mehta, Santa Clara, CA (US)

(21) Appl. No.: 15/395,779

(22) Filed: Dec. 30, 2016

Related U.S. Application Data
(60) Provisional application No. 62/352,390, filed on Jun. 20, 2016.

(51) Int. Cl. H04W 64/00; H04W 8/00

(52) U.S. Cl. CPC H04W 64/006; H04W 8/005

(57) ABSTRACT

Techniques disclosed herein are generally directed toward providing customized location database information regarding terrestrial transceivers to a mobile device (e.g., a semi-connected mobile device) by causing the mobile device to scan for terrestrial transceivers during a first period of time, provide a list of the terrestrial transceivers detected during the first period of time to a location server, and receive location information for terrestrial transceivers on the list. Using this location information, the mobile device can subsequently (e.g., during a second period of time) calculate its position when the terrestrial transceivers are detected.

### RELATED APPLICATIONS

This application claims the benefit of U.S. Provisional Application No. 62/352,390, filed Jun. 20, 2016, entitled “OFFLINE DOWNLOAD OF ASSISTANCE DATABASE TO ENABLE BEACON-BASED POSITIONING IN SEMI-CONNECTED DEVICES”, which is assigned to the assignee hereof, and incorporated herein in its entirety by reference.

### BACKGROUND

Non-limiting and non-exhaustive aspects are described with reference to the following figures, wherein like reference numerals refer to like parts throughout the various figures unless otherwise specified.

Mobile device positioning can be done in various ways, including using wireless radio frequency (RF) technologies in a database-based mobile device positioning system to help determine the location of a mobile device using terrestrial transceivers. In such systems, the distances between the mobile device and various terrestrial transceivers can be measured, and the position of the mobile device can be calculated (e.g., by performing trilateration) using the known coordinates of the terrestrial transceivers, which are kept in a database. The mobile device's position is typically calculated either by (1) a location server that receives distance measurements from the mobile device, or (2) by the mobile device that downloads coordinates of the terrestrial transceivers at the time of position fix calculation. In either of these approaches, however, a connectivity is typically required at the time the position fix is calculated. This can pose a problem to devices that are not in communication with the location server at that time.

### SUMMARY

Techniques disclosed herein are generally directed toward providing customized location database information regarding terrestrial transceivers to a mobile device (e.g., a semi-connected mobile device) by causing the mobile device to scan for terrestrial transceivers during a first period of time, provide a list of the terrestrial transceivers detected during the first period of time to a location server, and receive location information for terrestrial transceivers on the list. Using this location information, the mobile device can subsequently (e.g., during a second period of time) calculate its position when the terrestrial transceivers are detected.

An example mobile device, according to the description, comprises a communication interface, a memory, and a processing unit. The processing unit is configured to cause the mobile device to, during a first period of time during which the mobile device does not have Internet connectivity over a wireless local area network (WLAN), local area network (LAN), or personal area network (PAN), or combination thereof, wirelessly detect, using the communication interface, a plurality of terrestrial transceivers, and store identity information for each of the plurality of terrestrial transceivers in the memory. The processing unit is further configured to cause the mobile device to determine a priority value of each of the plurality of terrestrial transceivers and, after the first period of time and in response to establishing Internet connectivity over WLAN, LAN, PAN, or a combination thereof, establish a first communication link with a first location server; The processing unit is further configured to cause the mobile device to send, via the communication interface, the identity information for at least a portion of the plurality of terrestrial transceivers to the first location server, wherein the at least the portion of the plurality of terrestrial transceivers comprises terrestrial transceivers having at least a threshold priority value, and receive, from the first location server via the communication interface, location information for the at least the portion of the plurality of terrestrial transceivers.

The mobile device may include one or more of the following features. The processing unit may be configured to, for a second period of time during which the mobile device does not have the Internet connectivity over WLAN, LAN, PAN, or a combination thereof, detect, using the communication interface, one or more of the at least the portion of the plurality of terrestrial transceivers; and determine a position of the mobile device by using the location information for the one or more of the at least the portion of the plurality of terrestrial transceivers. The processing unit may be configured to cause the mobile device to, for each of the plurality of terrestrial transceivers, determine the priority value of the terrestrial transceiver based on a frequency of detection of the terrestrial transceiver, a number of times that the terrestrial transceiver is detected (over a particular period of time or historically over the life of the mobile device), a time of detection of the terrestrial transceiver, a signal strength of the terrestrial transceiver, a location of the terrestrial transceiver, a context of the terrestrial transceiver, a correlation of observability of the terrestrial transceiver, an age of detection of the terrestrial transceiver, or a duration of detection of the terrestrial transceiver, or any combination thereof. The processing unit may be configured to cause the mobile device to send the identity information for the plurality of terrestrial transceivers to the first location server based on a determination that the priority value of each of the plurality of terrestrial transceivers meets the threshold priority value. The processing unit may comprise a first processor configured to cause the mobile device to wirelessly detect the plurality of terrestrial transceivers and a second processor configured to cause the mobile device to send the identity information for the at least the portion of the plurality of terrestrial transceivers to the first location server. The processing unit is configured to cause the mobile device to, for a second period of time during which the mobile device does not have Internet connectivity over WLAN, LAN, PAN, or a combination thereof, wirelessly detect, using the communication interface, one or more additional terrestrial transceivers, and store identity information for each of the one or more additional terrestrial transceivers in the memory, and after the second period of time and in response to establishing Internet connectivity over WLAN, LAN, PAN, or a combination thereof, establish a second communication link with a second location server; and send, via the communication interface, the identity information for the one or more additional terrestrial transceivers to the second location server. The second location server may be a different server than the first location server. The processing unit may be further configured to cause the mobile device to receive, from the second location server, location information for the one or more additional terrestrial transceivers, and store the location information for the one or more additional terrestrial transceivers in the memory. The processing unit may be configured to cause the mobile device to increase a rate at which the mobile device conducts scans for terrestrial transceivers in response to determining that the mobile device is moving.

An example method of managing terrestrial transceiver positioning downloads by a mobile device, according to the description, comprises, during a first period of time during which the mobile device does not have Internet connectivity over a wireless local area network (WLAN), local area network (LAN), or personal area network (PAN), or combination thereof, wirelessly detecting a plurality of terrestrial transceivers using a communication interface of the mobile device, and storing identity information for each of the plurality of terrestrial transceivers in a memory of the mobile device. The method further comprises determining a priority value of each of the plurality of terrestrial transceivers, and, after the first period of time and in response to the mobile device establishing Internet connectivity over WLAN, LAN, PAN, or a combination thereof, establishing, via the communication interface of the mobile device, a first communication link between the mobile device and a first location server. The method further comprises sending, via the communication interface of the mobile device, the identity information for at least a portion of the plurality of terrestrial transceivers to the first location server, wherein the at least the portion of the plurality of terrestrial transceivers comprises terrestrial transceivers having at least a threshold priority value, and receiving, via the communication interface of the mobile device, location information for the at least the portion of the plurality of terrestrial transceivers.

The method can include one or more of the following features. The method may further comprise, for a second period of time during which the mobile device does not have the Internet connectivity over WLAN, LAN, PAN, or a combination thereof, detecting, using the communication interface of the mobile device, one or more of the at least the portion of the plurality of terrestrial transceivers; and determining, using a processor of the mobile device, a position of the mobile device by using the location information for the one or more of the at least the portion of the plurality of terrestrial transceivers. The method may further comprise, for each of the plurality of terrestrial transceivers, determining the priority value of the terrestrial transceiver based on a frequency of detection of the terrestrial transceiver, a number of times that the terrestrial transceiver is detected (over a particular period of time or historically over the life of the mobile device), a time of detection of the terrestrial transceiver, a signal strength of the terrestrial transceiver, a location of the terrestrial transceiver, a context of the terrestrial transceiver, a correlation of observability of the terrestrial transceiver, an age of detection of the terrestrial transceiver, or a duration of detection of the terrestrial transceiver, or any combination thereof. The method may comprise sending the identity information for the plurality of terrestrial transceivers to the first location server based on a determination that the priority value of each of the plurality of terrestrial transceivers meets the threshold priority value. The method may further comprise using a first processor of the mobile device to wirelessly detect the plurality of terrestrial transceivers and using a second processor of the mobile device to send the identity information for the at least the portion of the plurality of terrestrial transceivers to the first location server. The method may further comprise, for a second period of time during which the mobile device does not have Internet connectivity over WLAN, LAN, PAN, or a combination thereof, wirelessly detecting, using the communication interface of the mobile device, one or more additional terrestrial transceivers, and storing identity information for each of the one or more additional terrestrial transceivers in the memory of the mobile device, and, after the second period of time and in response to establishing Internet connectivity over WLAN, LAN, PAN, or a combination thereof, establishing, via the communication interface of the mobile device, a second communication link with a second location server; and sending, via the communication interface of the mobile device, the identity information for the one or more additional terrestrial transceivers to the second location server. The method may further comprise receiving, by the mobile device from the second location server, location information for the one or more additional terrestrial transceivers, and storing the location information for the one or more additional terrestrial transceivers in the memory of the mobile device. The method may further comprise, in response to determining that the mobile device is moving, increasing a rate at which the mobile device conducts scans for terrestrial transceivers.

An example apparatus, according to the description, comprises means for, during a first period of time during which the apparatus does not have Internet connectivity over a wireless local area network (WLAN), local area network (LAN), or personal area network (PAN), or combination thereof wirelessly detecting a plurality of terrestrial transceivers, and storing identity information for each of the plurality of terrestrial transceivers. The apparatus further comprises means for determining a priority value of each of the plurality of terrestrial transceivers, means for, after the first period of time and in response to establishing Internet connectivity over WLAN, LAN, PAN, or a combination thereof, establishing a first communication link between with a first location server, means for sending the identity information for at least a portion of the plurality of terrestrial transceivers to the first location server, wherein the at least the portion of the plurality of terrestrial transceivers comprises terrestrial transceivers having at least a threshold priority value, and means for receiving location information for the at least the portion of the plurality of terrestrial transceivers.

The apparatus may comprise one or more of the following features. The apparatus may further comprise means for, for a second period of time during which the apparatus does not have the Internet connectivity over WLAN, LAN, PAN, or a combination thereof, detecting one or more of the at least the portion of the plurality of terrestrial transceivers and determining a position of the apparatus by using the location information for the one or more of the at least the portion of the plurality of terrestrial transceivers. The apparatus may further comprise, for each of the plurality of terrestrial transceivers, means for determining the priority value of the terrestrial transceiver based on a frequency of detection of the terrestrial transceiver, a number of times that the terrestrial transceiver is detected (over a particular period of time or historically over the life of the apparatus), a time of detection of the terrestrial transceiver, a signal strength of the terrestrial transceiver, a location of the terrestrial transceiver, a context of the terrestrial transceiver, a correlation of observability of the terrestrial transceiver, an age of detection of the terrestrial transceiver, or a duration of detection of the terrestrial transceiver, or any combination thereof. The apparatus may further comprise means for sending the identity information for the plurality of terrestrial transceivers to the first location server based on a determination that the priority value of each of the plurality of terrestrial transceivers meets the threshold priority value. The apparatus may further comprise first processing means configured cause the apparatus to wirelessly detect the plurality of terrestrial transceivers and second processing means configured cause the apparatus send the identity information for the at least the portion of the plurality of terrestrial transceivers to the first location server. The apparatus may further comprise means for, for a second period of time during which the apparatus does not have Internet connectivity over WLAN, LAN, PAN, or a combination thereof, wirelessly detecting one or more additional terrestrial transceivers, and storing identity information for each of the one or more additional terrestrial transceivers, and means for, after the second period of time and in response to establishing Internet connectivity over WLAN, LAN, PAN, or a combination thereof, establishing a second communication link with a second location server and sending the identity information for the one or more additional terrestrial transceivers to the second location server. The apparatus may further comprise means for receiving, from the second location server, location information for the one or more additional terrestrial transceivers, and means for storing the location information for the one or more additional terrestrial transceivers. The apparatus may further comprise means for, in response to determining that the apparatus is moving, increasing a rate at which the apparatus conducts scans for terrestrial transceivers.

A non-transitory computer-readable medium, according to the disclosure, comprises instructions embedded thereon for managing terrestrial transceiver positioning downloads by a mobile device. The instructions include computer code for, during a first period of time during which the mobile device does not have Internet connectivity over a wireless local area network (WLAN), local area network (LAN), or personal area network (PAN), or combination thereof, wirelessly detecting a plurality of terrestrial transceivers, and storing identity information for each of the plurality of terrestrial transceivers. The instructions further comprise computer code for determining a priority value of each of the plurality of terrestrial transceivers, and, after the first period of time and in response to the mobile device establishing Internet connectivity over WLAN, LAN, PAN, or a combination thereof, establishing a first communication link between the mobile device and a first location server. The instructions further comprise computer code for sending the identity information for at least a portion of the plurality of terrestrial transceivers to the first location server, wherein the at least the portion of the plurality of terrestrial transceivers comprises terrestrial transceivers having at least a threshold priority value, and receiving location information for the at least the portion of the plurality of terrestrial transceivers.

The non-transitory computer-readable medium can include one or more of the following features. The instructions may comprise computer code for, for a second period of time during which the mobile device does not have the Internet connectivity over WLAN, LAN, PAN, or a combination thereof, detecting, using the communication interface of the mobile device, one or more of the at least the portion of the plurality of terrestrial transceivers, and determining, using a processor of the mobile device, a position of the mobile device by using the location information for the one or more of the at least the portion of the plurality of terrestrial transceivers. The instructions may comprise computer code for, for each of the plurality of terrestrial transceivers, determining the priority value of the terrestrial transceiver based on a frequency of detection of the terrestrial transceiver, a number of times that the terrestrial transceiver is detected (over a particular period of time or historically over the life of the mobile), a time of detection of the terrestrial transceiver, a signal strength of the terrestrial transceiver, a location of the terrestrial transceiver, a context of the terrestrial transceiver, a correlation of observability of the terrestrial transceiver, an age of detection of the terrestrial transceiver, or a duration of detection of the terrestrial transceiver, or any combination thereof. The instructions may comprise computer code for using a first processor of the mobile device to wirelessly detect the plurality of terrestrial transceivers and using a second processor of the mobile device to send the identity information for the at least the portion of the plurality of terrestrial transceivers to the first location server. The instructions may comprise computer code for, for a second period of time during which the mobile device does not have Internet connectivity over WLAN, LAN, PAN, or a combination thereof wirelessly detecting one or more additional terrestrial transceivers, and storing identity information for each of the one or more additional terrestrial transceivers, and after the second period of time and in response to establishing Internet connectivity over WLAN, LAN, PAN, or a combination thereof establishing a second communication link with a second location server; and sending the identity information for the one or more additional terrestrial transceivers to the second location server.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a simplified illustration of an embodiment of a positioning system used to determine a location of a semi-connected mobile device, which may implement the techniques described herein for downloading assistance data.

FIG. 2 is a simplified overhead view of a map provided to help illustrate how a semi-connected mobile device can scan for terrestrial transceivers, according to some embodiments.

FIG. 3 is a timeline that models an use case for the techniques of terrestrial transceiver-based positioning data download provided herein, according to one embodiment.

FIG. 4 is a flow diagram of an example method of obtaining terrestrial transceiver-based positioning data, according to an embodiment.

FIG. 5 illustrates an embodiment of a semi-connected mobile device 105, which can be utilized in the embodiments described herein.

FIG. 6 illustrates an embodiment of a computer system, which may comprise or be incorporated, at least in part, into devices capable of operating as a location server as described herein above.

### DETAILED DESCRIPTION

Several illustrative embodiments will now be described with respect to the accompanying drawings, which form a part hereof. The ensuing description provides embodiment(s) only, and is not intended to limit the scope, applicability or configuration of the disclosure. Rather, the ensuing description of the embodiment(s) will provide those skilled in the art with an enabling description for implementing an embodiment. It is understood that various changes may be made in the function and arrangement of elements without departing from the spirit and scope of this disclosure.

The subject matter disclosed herein generally relates to mobile device positioning, which can be implemented by a positioning system. These systems can use one or more databases of cellular, Wi-Fi®, Bluetooth®, and/or several other types of wireless radio frequency (RF) technologies to help determine the location of a mobile device using terrestrial transceivers. (The determination of the location of the semi-connected mobile device is also referred to herein as a “position fix” or “location fix”). The location of the mobile devices typically calculated using known locations of terrestrial transceivers, which are typically stored by a location server (e.g., in a database maintained by and/or otherwise accessible to the location server), along with wireless measurements of distances between the beacons and the mobile device. (As provided herein, the term “beacons” or “terrestrial transceivers” can refer to any of a variety of terrestrial devices, and/or other terrestrial systems that communicate wirelessly and may be identified by receiving at least a portion of this wireless communication. Such devices may include wireless access points, cellular base stations, Bluetooth beacons, and the like.)

In traditional database-based mobile device positioning systems, the position fix calculation is typically performed using one of two approaches. The first approach involves the location server performing the position fix calculation by receiving distance measurements (e.g., measurements of distances between the mobile device and terrestrial transceivers) and/or other information from a mobile device in order to perform the calculation by using known locations of terrestrial transceivers (e.g., as stored by a location database). The second approach involves the mobile device performing the position fix calculation by downloading a geographically relevant portion of the location database from the location server stored at the time of position fix calculation. In either of these approaches, however, a connectivity is typically required at the time the position fix is calculated.

Requiring connectivity at the time of a position fix can be challenge in several scenarios where devices are “semi-connected.” As used herein, the term “semi-connected” generally refers to a device that is not typically connected to the Internet or otherwise in connection with a location server at the time of performing a database-based mobile device position fix. Semi-connected devices can exist in various scenarios including, for example, wearables (such as watches or other wearable devices that infrequently have access to the Internet or other network), emerging markets where mobile data costs are still very high (thus encouraging users to turn off the cellular data most of the time and rely upon Wi-Fi connectivity, which may not be ubiquitous), tablets, and other Wi-Fi-only and/or non-cellular devices. It can be noted that, although embodiments describe a semi-connected mobile device, the techniques herein may be applied to other devices that may not be considered semi-connected mobile devices.

Although providing a position fix may not have been a priority feature in the past, a large amount of applications now utilize location information. These applications include, for example, fitness apps, geotagged pictures, location-based reminders, and so forth. Furthermore, many of these applications are indoor applications in which it is important to utilize database-based mobile device positioning systems (e.g., Wi-Fi Based) where GPS positioning may not be available. Because of this, database-based mobile device positioning systems that rely on connectivity at the time of performing a location fix can experience problems when dealing with semi-connected mobile devices.

Techniques disclosed herein address this and other issues by (1) enabling semi-connected mobile devices to implement learning-based algorithms to identify terrestrial transceivers (utilizing cellular base stations, Wi-Fi, Bluetooth, Bluetooth Low Energy (BTLE), and/or other technologies) that may be highly relevant to the end user device, (2) opportunistically downloading the database for these identified terrestrial transceivers from the server when device has connectivity, and (3) device-based learning of terrestrial transceiver locations. These and other techniques are discussed in further detail below and in the appended figures. It will be appreciated that, although the embodiments discussed below and in the appended figures may describe specific implementations (e.g., certain techniques for storing a list of terrestrial transceivers with a semi-connected mobile device, the use of a particular type of positioning server, etc.) embodiments are not so limited. A person of ordinary skill in the art will appreciate that various alterations may be made to the embodiments described herein.

Benefits of utilizing the techniques herein include, but are not limited to, reducing data usage for semi-connected mobile devices connected to a wireless wide area network (WWAN) (such as a cellular network), reducing bandwidth and other resource requirements of the WWAN, location servers, and/or semi-connected mobile devices, and more.

It can be noted that, the “list of terrestrial transceivers” described in the embodiments that follow may be implemented in any of a variety of ways. For example, this information may be stored in a database, linked list, and/or other data structure in the memory of a semi-connected mobile device.

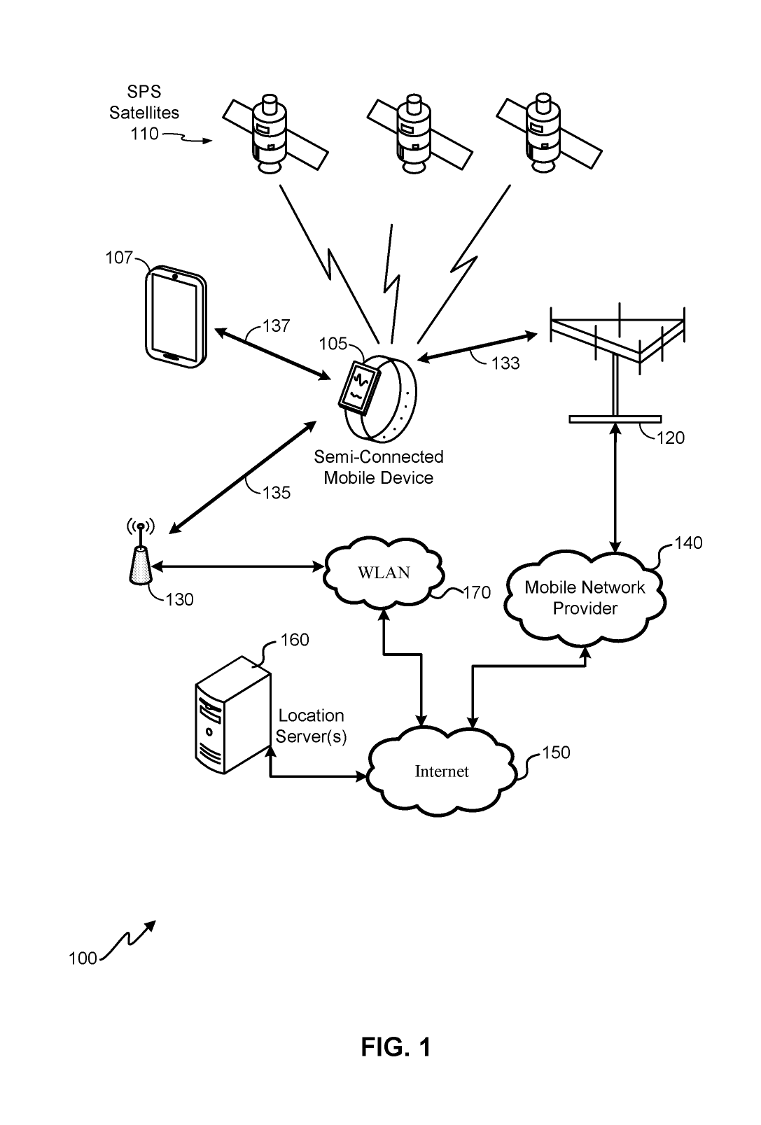

FIG. 1 is a simplified illustration of an embodiment of a positioning system 100 used to determine a location of a semi-connected mobile device 105, which may implement the techniques described herein for downloading assistance data. The techniques described herein may therefore be implemented by one or more components of the positioning system 100. The positioning system can include a semi-connected mobile device 105, a connecting device 107, satellite positioning service (SPS) satellite vehicles (SVs) 110, base transceiver station(s) 120, mobile network provider 140, access point(s) (AP(s)) 130, location server 160, wireless local area network (WLAN) 170, and the Internet 150. It can be noted that the positioning system 100 includes both non-terrestrial positioning (e.g., via SPS satellites 110), as well as positioning via terrestrial transceivers. Here, terrestrial transceivers can include APs 130 and/or base transceiver station(s) 120, which are communicatively coupled with the location server 160. It can further be noted that a plurality of location servers may be utilized, and different location servers make correspond with different types of terrestrial transceivers (which may be maintained by different entities). Thus, in some embodiments, there may be one location server for APs 130 and another location server for base transceiver station(s) 120.

It should be noted that FIG. 1 provides only a generalized illustration of various components, any or all of which may be utilized as appropriate, and each of which may be duplicated as necessary. Specifically, although only one semi-connected mobile device 105 is illustrated, it will be understood that many mobile devices (e.g., hundreds, thousands, millions, etc.) may be utilized in the positioning system 100. Similarly, the positioning system 100 may include many base transceiver station(s) 120 and/or APs 130. The illustrated connections that connect the various components in the positioning system 100 comprise data connections which may include additional (intermediary) components, direct or indirect connections, and/or additional networks. Furthermore, components may be rearranged, combined, separated, substituted, and/or omitted, depending on desired functionality. A person of ordinary skill in the art will recognize many modifications to the components illustrated.

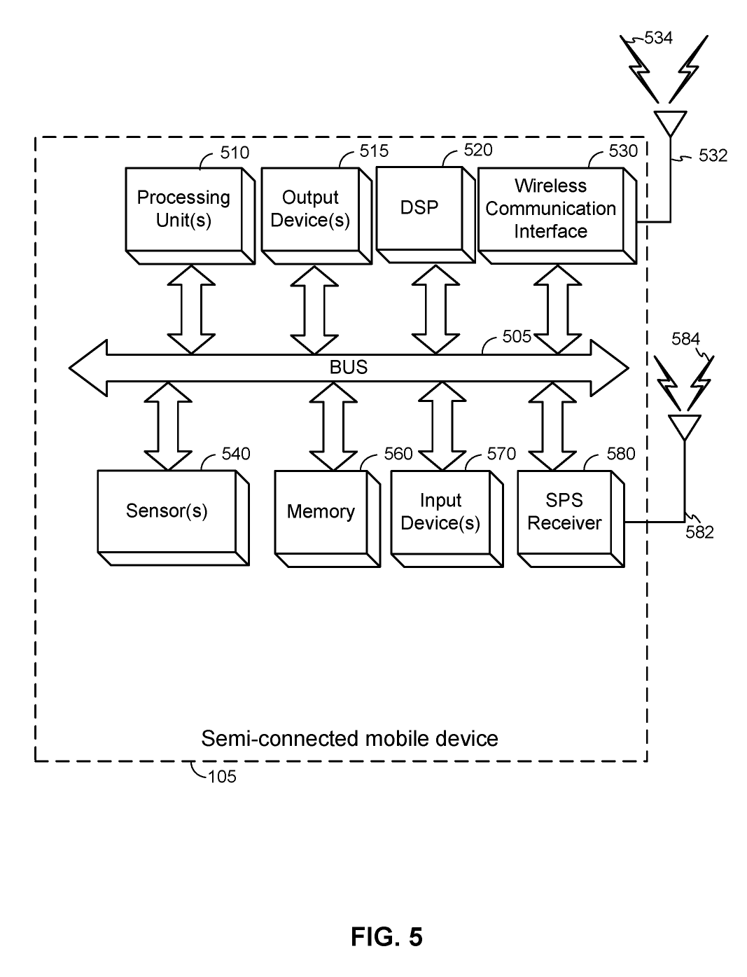

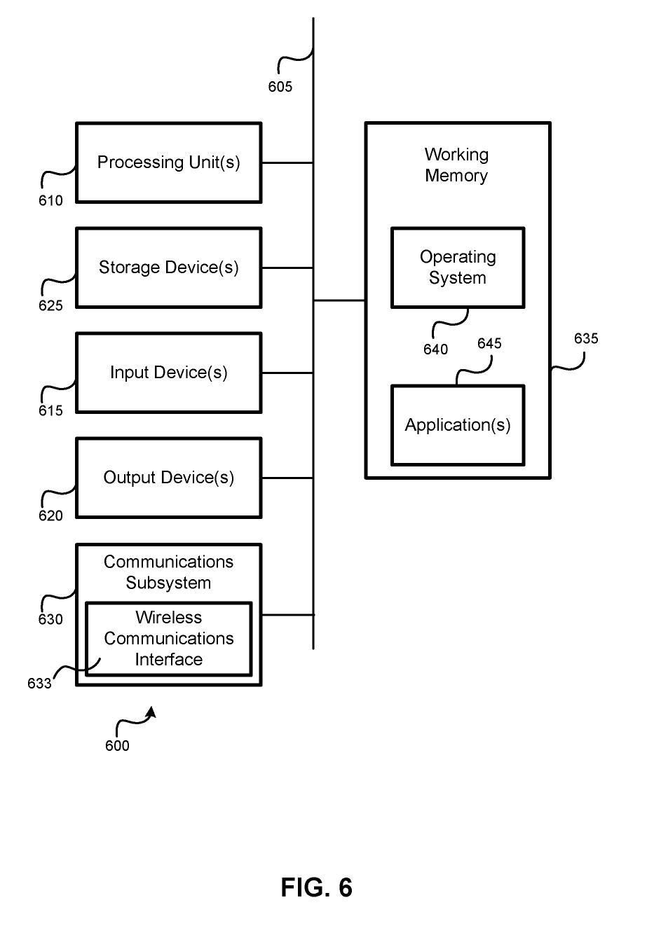

The base transceiver station(s) 120 is/are communicatively coupled to the mobile network provider 140 (such as a cell phone network) which may be communicatively coupled with the Internet 150. In some embodiments, the base transceiver station(s) 120 may employ any of a variety of wireless technologies, as described herein below with regard to FIGS. 5-6. The location server(s) 160 can also be communicatively coupled with the Internet 150. Thus, the semi-connected mobile device 105 can communicate with the location server(s) 160, for example, by accessing the Internet 150 via the antenna 120 using a first communication link 133. Additionally or alternatively, because an AP 130 and WAN 170 also may be communicatively coupled with the Internet 150, the mobile device 105 may communicate with the location server(s) 160 using a second communication link 135.

In some embodiments, the semi-connected mobile device 105 may additionally or alternatively communicate with the location server 160 via the connecting device 107. The synchronized device may comprise a mobile or fixed device (e.g., a cell phone, network hub, proprietary synchronization device, etc.) that may provide a data connection between the semi-connected mobile device 105 and the location server 160. In some embodiments, for example, the connecting device 107 may communicate with the APs 130, transceiver station(s) 120 and/or SPS satellites 110, in which case the semi-connected mobile device may communicate with the location server 160 via a wireless communication link 137 between the semi-connected mobile device 105 and the connecting device 107. In such embodiments, the semi-connected mobile device 105 may not send and/or receive data with APs 130, antenna 120, and/or SPS satellites 110, except the via a the connecting device 107 once the wireless communication link 137 between the semi-connected mobile device 105 and the connecting device 107 has been established (e.g., when the semi-connected mobile device 105 and the connecting device 107 are synchronizing).

Depending on desired functionality, a location of the semi-connected mobile device 105 can be determined in any of a variety of ways, by the semi-connected mobile device and/or other devices in communication with the semi-connected mobile device, which may be situation dependent. SPS satellites 110 may be used to provide global positioning, in which case the semi-connected mobile device 105 and/or the connecting device 107 receives timing signals from the SPS satellites 110 using an SPS receiver and calculates a global position based on the received timing signals.

Database-based mobile device positioning may be used additionally or alternatively. As previously mentioned, database-based mobile device positioning is conducted using terrestrial transceivers (e.g., APs 130, transceiver station(s) 120, and/or other transceivers or beacons (not shown)) and the location server(s) 160. The location server(s) 160 may maintain and/or have access to a database with the known locations of the various terrestrial transceivers. Furthermore, the semi-connected mobile device 105 and/or terrestrial transceivers may measure the distance between the semi-connected mobile device 105 and/or terrestrial transceivers (e.g., using wireless measurements such as round trip time (RTT), received signal strength indication (RSSI), angle of arrival (AOA), and/or the like). With these known locations and distance measurements, the position of the semi-connected mobile device 105 can be calculated (by the semi-connected mobile device 105 and/or the location server(s) 160) using trilateration, triangulation, and/or similar techniques.

As previously indicated, because the semi-connected mobile device 105 may not be in communication with the location server(s) 160 at the time of a desired position fix, the semi-connected mobile device 105 may rely on a location database locally stored by the semi-connected mobile device 105, rather than communicating with the location server(s) 160 to calculate a position fix. The locally-stored location database can comprise similar information as the database of the location server(s) 160. However, because of limitations in memory and/or other concerns, the semi-connected mobile device 105 can download a customized location database with location information for terrestrial transceivers pertinent to the semi-connected mobile device 105. To do this, the semi-connected mobile device 105 can first determine which terrestrial transceivers should be included in the locally-stored location database.

According to some embodiments, the semi-connected mobile device 105 device can build and maintain a list of terrestrial transceivers it detects. That is the semi-connected mobile device 105 can scan for wireless signals from terrestrial transceivers, identify the terrestrial transceivers, and add the terrestrial transceivers to its list of terrestrial transceivers for which location information is to be downloaded. According to various protocols and standards, for example, terrestrial transceivers will periodically transmit openly-advertised frames (e.g., Beacon Frames of Wi-Fi APs) that can, among other things, include identification information. This identification information can be used by the semi-connected mobile device 105 to identify a terrestrial transceiver and add it to the list of terrestrial transceivers it maintains. It can be noted that the detected terrestrial transceivers do not necessarily have to provide a data connection to the semi-connected mobile device 105. Instead the semi-connected mobile device 105 may simply identify these terrestrial transceivers by passively scanning to broadcasted advertising frames (or similar information) from these terrestrial transceivers during typical operation of the semi-connected mobile device 105.

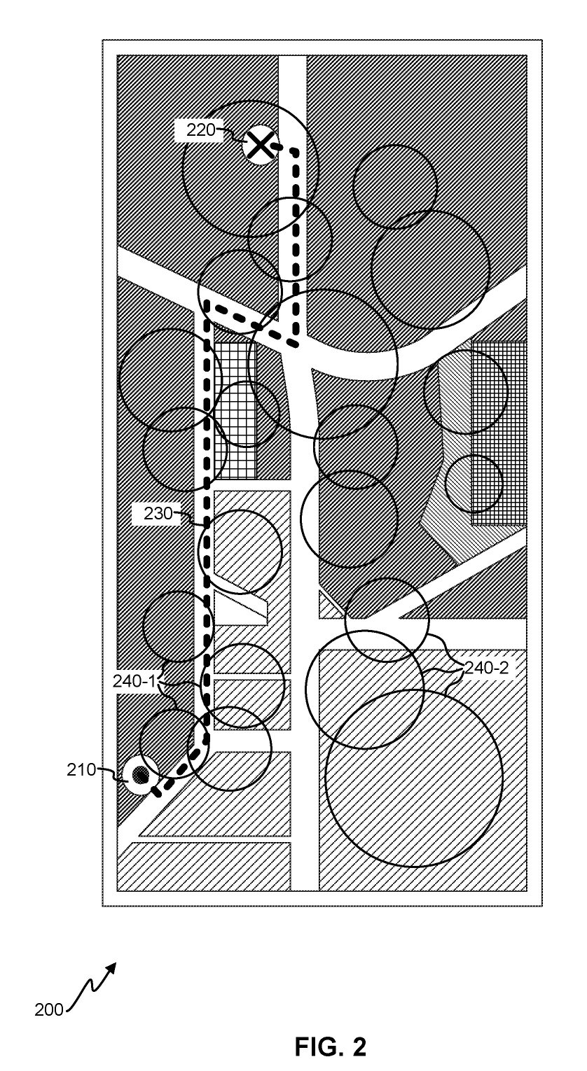

FIG. 2 is a simplified overhead view of a map 200 provided to help illustrate how a semi-connected mobile device can scan for terrestrial transceivers, according to some embodiments. Here, the map 200 can represent a geographic location in which the semi-connected mobile device travels, in this example, from a starting location 210 along a course of travel 230 to an ending location 220. Areas of coverage 240-1 and 240-2 (collectively referred to herein as 240) of terrestrial transceivers are represented in FIG. 2 as circles, one for each terrestrial transceiver. If the semi-connected mobile device enters within an area of coverage 240 (i.e., inside a circle) the semi-connected mobile device is able to detect the terrestrial transceiver corresponding to the area of coverage 240. (Note, to improve clarity, only a portion of the areas of coverage 240 illustrated in FIG. 2 are labeled.)

In traditional positioning systems, a mobile device may download location information for all terrestrial transceivers of a geographical region, regardless of where, within that region, the mobile device may travel. Location and identification information for terrestrial transceivers is generally called a “tile,” and tiles would traditionally be downloaded by a mobile device when he mobile device is determined to be inside or within the threshold distance of a geographical region represented by the tile. Thus, for example, a mobile device may, when nearing the geographical region illustrated by the map 200 of FIG. 2, download a tile corresponding to all areas of coverage 240 in FIG. 2. This functionality not only requires connectivity at the time of tile download (e.g., when the mobile device is determined to be inside or within the geographical region illustrated by the map 200), but also involves identity and location information for areas of coverage 240-2 that may not be needed (because they do not overlap with the course of travel 230), and therefore unnecessarily occupying memory of the mobile device. This can be especially problematic for semi-connected mobile devices that may not have conductivity at the time a tile would traditionally be downloaded. Furthermore semi-connected mobile devices may not have a large amount of memory for storing tile information, so allocating memory resources to location information for areas of coverage 240-2 that may not be needed, may negatively impact the functionality of the semi-connected mobile device.

Embodiments provided herein enable a mobile device, particularly a semi-connected mobile device (which may not have connectivity to download a tile on-demand), to use its wireless radio transceiver(s) to scan for signals from terrestrial transceivers throughout the course of normal operation (e.g., when utilized without a data connection). For example, with regard to FIG. 2, a semi-connected mobile device may begin scanning for terrestrial transceivers at starting location 210 and continue to scan while traveling along a course of travel 230 to an ending location 220. Accordingly, the semi-connected mobile device can detect terrestrial transceivers corresponding to areas of coverage 240-1 that overlap with the course of travel 230. As various terrestrial transceivers are detected, their identities can be stored in a list of terrestrial transceivers maintained by the semi-connected mobile device. As described in further detail below, this list can then be provided to a location server, enabling the location server to provide a customized tile based on the list.

The method of scanning performed by the semi-connected mobile device can vary, depending on desired functionality. For example, scanning may be performed as part of normal device operation (e.g., when scanning for connectivity) and not necessarily implemented simply to establish the list of terrestrial transceivers. As such, scanning may not require much additional battery power or other resources of the semi-connected mobile device. Even so, some embodiments may provide for additional scanning to complement the scans made during normal operation of the semi-connected mobile device, thereby helping ensure sufficient collection of terrestrial transceiver information.

According to some embodiments, additional measurements can be taken to ensure that power consumption by the semi-connected mobile device during scanning is minimized. For example, scanning conducted by the semi-connected mobile device may be done by passively listening for scan results. Such scans may include, for example, Preferred Network Offload (PNO) scans, roaming scans, and/or host-triggered scans that may be routinely performed by a semi-connected mobile device for various other purposes. In some embodiments, scanning can be performed by wireless local area network (WLAN) firmware of the semi-connected mobile device which may be executed on a low-power processor (which may be distinct from the application processor) to reduce battery consumption and lower data usage. The low-power processor may be found, for example, in processing unit(s) 510 and/or in a wireless communication interface 530 of a mobile device, as shown in FIG. 10 and described in more detail below.

As previously noted, additional scanning may be made to complement the scans made during normal operation of the semi-connected mobile device. For example, in some embodiments, if these opportunistic scans (scans made during routine operation) fall below a particular scanning threshold or are otherwise determined to be insufficient for collection of terrestrial transceiver information, complementary scans may be performed. In such cases, a semi-connected mobile device may trigger complementary scanning in cases where it determines that opportunistic scanning is insufficient. Complementary scans may be based on any of a variety of events, including determined periodicity of opportunistic scans falling below a certain threshold, detection of a motion or movement (e.g., using one or more movement sensors of the semi-connected mobile device), detection of a threshold amount of new terrestrial transceivers during a previous scan, and the like.

After collection of terrestrial transceiver information (e.g., accumulating a list of identification information for terrestrial transceivers detected by scanning), the semi-connected mobile device can then download a customized tile with location information for the identified terrestrial transceivers on the list. This can occur opportunistically when the semi-connected mobile device is connected to the Internet or otherwise communicatively coupled with a location server (e.g., via a connection to a wireless access point, via a synchronized device, etc.). Here, the tile download does not need to correspond with a location fix. As opposed to traditional database-based mobile device positioning in which a mobile device will communicate with a location server during a position fix (or access a previously downloaded tile to determine terrestrial transceiver location information for location determination), techniques described herein enable a semi-connected mobile device to communicate with a location server when connected (e.g., whether or not a position fix is requested). In doing so, the semi-connected mobile device can provide the location server with identification of the terrestrial transceivers on its list (for which the semi-connected mobile device does not yet have location information), and the location server can respond by providing a customized tile with location information for these terrestrial transceivers.

Accordingly, by utilizing this process, a semi-connected mobile device essentially receives a customized tile based on where the semi-conducted mobile device has been. For example, a user may have a smart watch (or other wearable device) that, to conserve power and/or for other reasons, is connected to the Internet only on occasion (such as when the smart watches synchronizes with a smartphone). During its first day of use (before a list of terrestrial transceivers has been created), the smart watch can regularly perform scans to determine what terrestrial transceivers are detectable along the user's customary route of travel (e.g., the route of travel 230 of FIG. 2), adding the detected terrestrial transceivers (e.g., those corresponding to areas of coverage 240-1 overlapping with the route of travel 230) to its list. Because the smart watch may not yet know the location of these terrestrial transceivers, it may not yet be able to provide a location fix. However, the user may return home at the end of the day, and the smart watch may connect with the home Wi-Fi connection and/or synchronize with a mobile device, providing the smart watch with a connection through which it can communicate with a location server. The smart watch can then provide identification information of the terrestrial transceivers in its list of detected terrestrial transceivers, and location server can response by providing the smart watch with a tile that has location information for the terrestrial transceivers. Subsequently, the smart watch may be able to provide location fixes in places where these previously-detected terrestrial transceivers are again detected. As provided in more detail below, learning algorithms may be implemented to help the smart watch determine patterns within routes of travel, prioritize the terrestrial transceivers on the list of terrestrial transceivers, and/or perform other functions that can improve the accuracy and applicability of the information downloaded from the location server.

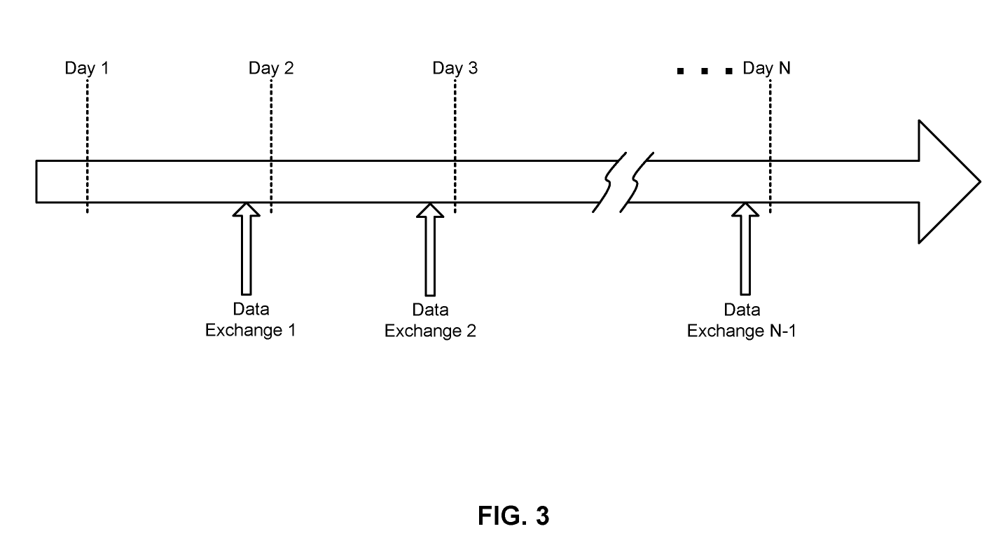

FIG. 3 is a timeline that models an use case for the techniques of terrestrial transceiver-based positioning data download provided herein, according to one embodiment. In this use case, a semi-connected mobile device (such as a wearable, Wi-Fi only tablet, data-tariff-sensitive user/carrier, or Wi-Fi enabled camera, etc.) connects with a location server on a daily basis. Using one or more machine learning algorithms, the semi-connected mobile device can provide accurate positioning in virtually all places frequently visited by the user of the semi-connected mobile device by Day N. The process in this use case can proceed generally as follows.

On Day 1 the semi-connected mobile device, perhaps because it is new, does not have a list of detected terrestrial transceivers. The semi-connected mobile device therefore may not be able to provide database-based mobile device positioning because it may not have access to a database (either remotely via an Internet connection or locally via a download) that would provide location information for terrestrial transceivers detected by the semi-connected mobile device from which a location could be calculated. Instead, on Day 1 the semi-connected mobile device performs scans to detect terrestrial transceivers, accumulating a list of terrestrial transceivers detected throughout the day. At the end of the day, when the semi-connected mobile device has established a data connection with a location server (e.g., via a Wi-Fi connection), the semi-connected mobile device can provide the location server with the identity of the detected terrestrial transceivers and receive in return a tile with location information for the terrestrial transceivers (indicated as “Data Exchange 1” in FIG. 3).

On Day 2 and subsequent days the semi-connected mobile device is able to provide database-based mobile device positioning by calculating its position at locations where it detects terrestrial transceivers that are in the list of terrestrial transceivers and have associated location information. Furthermore, the semi-connected mobile device can continue to scan for terrestrial transceivers, gathering information regarding terrestrial transceivers that have not yet been detected or for which the semi-connected mobile device has not yet received associated location information. At the end of each day, the semi-connected mobile device can establish a connection with the location server and receive location information for the additional terrestrial transceivers detected throughout that day. Over the course of time, machine learning algorithms implemented by the semi-connected mobile device can learn which terrestrial transceivers are most commonly detected and which are infrequently detected. This can enable these algorithms to optimize the list of terrestrial transceivers such that it retains location information for terrestrial transceivers determined to be “important” to the semi-connected mobile device. That is, the semi-connected mobile device can establish and maintain a list of terrestrial transceivers that includes identification and location information for terrestrial transceivers that have been determined to have a threshold amount of relevance to the semi-connected mobile device. Additional details regarding learning algorithms that may be utilized are provided below.

Depending on desired functionality, any of a variety of alterations may be made to the embodiment illustrated in FIG. 3. In some embodiments, for example, positioning may be provided on Day 1. This can be done when a user provides an intended route of travel beforehand. In particular, embodiments may enable a user to provide (for example, using an application executed by the semi-connected mobile device or another device communicatively coupled there with) and intended route of travel. While the semi-connected mobile device has a connection with the location server, and before the user embarks on the intended route of travel, the semi-connected mobile device can then download identification and location information regarding terrestrial transceivers along the intended route of travel. Once downloaded, this information can then be used by the semi-connected mobile device to provide database-based mobile device positioning throughout Day 1. In the meantime, the semi-connected mobile device may still perform the functions illustrated in FIG. 3 to build and maintain a list of terrestrial transceivers that is customized to the user's customary route of travel.

As previously indicated, the semi-connected mobile device can use machine learning algorithms to determine terrestrial transceivers are most commonly detected and which are infrequently detected. In some embodiments, for example, the list of terrestrial transceivers maintained by the semi-connected mobile device can be impacted by available memory and determined importance. For example if there is little available memory (e.g., less than a threshold amount), the semi-connected mobile device can rank terrestrial transceivers based on various important factors to determine which terrestrial transceivers should remain in the list of terrestrial transceivers, and which may be purged. (If there are no issues of memory, the semi-connected mobile device may retain identification information for all terrestrial transceivers, and/or provide a lower threshold by which terrestrial transceiver information is retained in the list of terrestrial transceivers.) To determine its relative importance, each terrestrial transceiver can be ranked based on one or more of a variety of factors.

One such factor is the number of times a terrestrial transceiver is observed by the semi-connected mobile device or the time period for which the terrestrial transceiver is observed. The greater number of times observed and/or the greater amount of time the terrestrial transceiver is observed can result in a higher determined importance.

Another factor is the “age” of the terrestrial transceiver. That is, the last time the terrestrial transceiver was detected by the semi-connected mobile device. The more recent a terrestrial transceiver is detected, the higher the determined importance. This provides for situations in which terrestrial transceivers that have not been detected for a relatively long time (e.g., longer than a threshold time.) can receive lower importance determinations, and eventually be purged from the list of terrestrial transceivers if its importance falls below a threshold importance value to remain on the list of terrestrial transceivers.

Another factor is a determined distance to a terrestrial transceiver. For example, the semi-connected mobile device can determine a distance to the terrestrial transceiver based on the power level of a detected signal (e.g. RSSI), an actual distance measurement (e.g., RTT measurement), and/or the like. Terrestrial transceivers that are perceived to be relatively close may receive a higher importance value than those that are relatively distant.

Another factor can be location-based. According to some embodiments, a particular location (or geographical area) can be identified as being important to a user. This identification may be provided directly by the user, or maybe determined by the semi-connected mobile device based on observable factors, such as frequency and/or length of stay at the location by the user. Additionally or alternatively, a location may be determined to be important based on the number of terrestrial transceivers in the location having an importance factor greater than a certain threshold. If, for example, a location has several terrestrial transceivers determined by the semi-connected mobile device to have a high importance, this may be a factor in determining that other terrestrial transceivers that are detectable at the location are also important.

According to some embodiments, a user input may further inform a determined importance of terrestrial transceivers. In some embodiments, for example, a user may provide an input indicative of travel to a new area. However the user may further indicate that this travel is unique, it is not expected to occur routinely. In such cases, the semi-connected mobile device may still scan for terrestrial transceivers at the new location. However, detected terrestrial transceivers at the new location may be given a lower importance, based on the fact that the user may not return to this location above a threshold frequency. Additionally or alternatively, the user may retroactively indicate that a new location visited was unique, and the semi-connected mobile device may reduce a determined importance value of each terrestrial transceiver detected at the new location based on this information. Alternatively, the semi-connected mobile device may remove terrestrial transceivers associated with a new location upon determining that the user has left the new location.

Embodiments may utilize any combination of factors (such as those described above) to determine an importance of a terrestrial transceiver, and these factors may be combined in any of a variety of ways. As an example, one embodiment may utilize the formula:

I=α*f−β*a−γ*d, (1)

to calculate the importance value, I, of a terrestrial transceiver. Here, frequency, f, is the number of times a terrestrial transceiver is observed, age, a, is a difference between a current time and a last time the terrestrial transceiver was detected, and distance, d, is a distance between a devices current location and the terrestrial transceiver's location. Remaining variables α, β, and γ are respective weighting factors for frequency, age, and distance, which can be given different values, depending on desired functionality. Using this formula, terrestrial transceivers at a new location (e.g., a vacation location of the user) may receive a high importance value because distance is minimized, and the importance values of prior importance terrestrial transceivers may be reduced due to their age. However, importance value of previously important terrestrial transceivers at home can be restored once the user returns home (due to distance, age, and frequency), and the importance value of terrestrial transceivers at the new location will be reduced (due to large distance and low frequency) and will decrease over time as age increases. Maintenance of the list of terrestrial transceivers maintained by the mobile device can vary, depending on importance value. For example, in some embodiments, terrestrial transceivers may need to have at least a threshold importance value to remain on the list of terrestrial transceivers maintained by the mobile device beyond a certain period or triggering event (e.g., when the list is uploaded to the location server). Additionally or alternatively, terrestrial transceivers on the list that are not detected for a threshold amount of time (e.g., 2 months) may be removed from the list (if not previously removed from the list for not having a sufficient importance value).

In some embodiments, when the mobile device is determined to be in a new location (e.g., as determined by the detection of a new transceiver and no detection of previous transceivers), a location server may provide the mobile device with a list of terrestrial transceivers for the new location. That is, the location server may have a list of default terrestrial transceivers for various locations, and when the mobile device is determined to be in one of those locations, the location server can provide the mobile device with information for default terrestrial transceivers corresponding to that location. The location server may determine to include terrestrial transceivers on a list corresponding to a certain location where the terrestrial transceivers are often detected together at that location. In some embodiments, depending on available memory, desired functionality, and/or other factors, a mobile device may maintain multiple lists of terrestrial transceivers corresponding to multiple locations.

In some embodiments, algorithms may be implemented to ensure self-learning location of terrestrial transceivers. That is, in a manner similar to the way in which a mobile device can determine which terrestrial transceivers are “important,” the mobile device can implement learning algorithms to determine a change in location of the terrestrial transceiver over time.

According to some embodiments, authentication and/or other protective measures may be taken to help guard against data theft. Data provided by the location server may be proprietary information that the administrating entity of the location server may want to protect. If unprotected, this location information may be obtained by a hacker that can use an application executed by a mobile device to obtain database information for various locations within the application server's serving area, ultimately acquiring all information on the location server's database. Embodiments may therefore employ any of a variety of protective measures to safeguard data on the location server. Such protective measures can include, for example, utilizing encryption to help ensure that only authorized applications have access to location information. Authorized applications executed by a semi-connected mobile device they receive encryption keys from a location server, enabling encrypted communication between the application and the location server. In such instances, a semi-connected mobile device may have a plurality of encryption keys corresponding to a plurality of authorized applications executed by the semi-connected mobile device. Other embodiments may employ other types of encryption and/or safeguards. Ultimately, the techniques provided herein may be utilized irrespective of whether communication between server and mobile device is encrypted or not.

Embodiments may additionally or alternatively help ensure the privacy and/or anonymity of user-related data. Before location data is communicated from a semi-connected mobile device to a location server, a user may first need to acknowledge a willingness to do so. Additionally or alternatively, the semi-connected mobile device may refrain from sending user-identifiable information to the location server and/or ensure that requests to and from the location server are encrypted. Such precautions can help prevent personal information of the user to be provided to location server (or application/device posing as a location server).

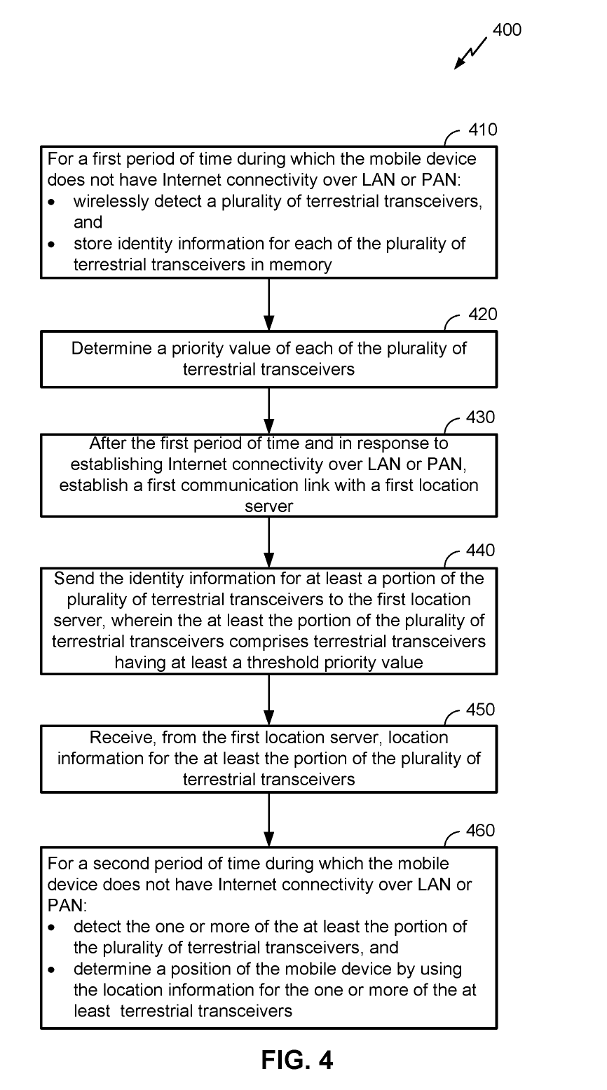

FIG. 4 is a flow diagram of an example method 400 of obtaining terrestrial transceiver-based positioning data, according to an embodiment. One or more of the functions depicted in the blocks illustrated in FIG. 4 may be performed by a mobile device or semi-connected mobile device as described in the embodiments provided above. The means for performing the functionality can include hardware and/or software components of a semi-connected mobile device, as shown in FIG. 5 and described in further detail below.

At block 410, during a first period of time during which the mobile device does not have Internet connectivity over a local area network (LAN) or personal area network (PAN), a plurality of terrestrial transceivers is detected, and identity information for each of the plurality of terrestrial transceivers is stored in memory. As indicated previously, terrestrial transceivers may be detected by a semi-connected mobile device using passive scanning or similar means. The techniques utilized for scanning may vary depending on the wireless technologies utilized, which may be subject to different standards and protocols. To help preserve power, some embodiments may use a low-power processor of the semi-connected mobile device (e.g., a modem processor) to perform this functionality, enabling a full- or high-power processor (e.g., an application processor) to remain in a low-power (sleep) state. In other words, where a semi-connected mobile device has an application processor separate from a low-power processor, the application processor may be configured to be in a first power state during the first period of time and a second power state when the semi-connected mobile device subsequently establishes a communication link with the location server, where the application processor consumes a lower amount of power when in the first power state than when in the second power state. The lower-power processor may be configured to cause the mobile device to wirelessly detect the plurality of terrestrial transceivers, and the application processor may be configured to cause the mobile device to send the identity information for the at least the portion of the plurality of terrestrial transceivers to the first location server (as shown in block 440 and described below).

Means for performing the functionality of block 410 can include, for example, processing unit(s) 510, DSP 520, wireless communication interface 530, bus 505, and/or memory 560 of a semi-connected mobile device 105, as illustrated in FIG. 5 and described below.

At block 420, a priority value of each of the plurality of terrestrial transceivers is determined. For example, a priority value may be determined by the semi-connected mobile device based a frequency of detection of the terrestrial transceiver, a number of times that the terrestrial transceiver is detected (over a particular period of time or historically over the life of the mobile), a time of detection of the terrestrial transceiver, a signal strength of the terrestrial transceiver, or a duration of detection of the terrestrial transceiver, or any combination thereof. In some embodiments, the rate at which the mobile device conducts scans for terrestrial transceivers may be increased by determining that the mobile device is moving and/or determining that the mobile device is located within a threshold distance of a boarder of a region in which the plurality of terrestrial transceivers are located.

Means for performing the functionality of block 420 can include, for example, processing unit(s) 510, DSP 520, bus 505, and/or memory 560 of a semi-connected mobile device 105, as illustrated in FIG. 5 and described below.

At block 430, after the first period of time and in response to establishing Internet connectivity over LAN or PAN, a communication link with a first location server is established. Depending on desired functionality, connectivity to the LAN or PAN may be via wired or wireless connection, directly or via a connecting device (such as the connecting device 107 of FIG. 1 or other device providing connectivity), according to some embodiments. The LAN or PAN may include a wireless LAN (WLAN) or wireless PAN (WPAN). Means for performing the functionality of block 430 can include, for example, processing unit(s) 510, DSP 520, wireless communication interface 530, bus 505, and/or memory 560 of a semi-connected mobile device 105, as illustrated in FIG. 5 and described below.

At block 440, the identity information for at least a portion of the plurality of terrestrial transceivers is sent to the first location server, where the at least the portion of the plurality of terrestrial transceivers comprises terrestrial transceivers having at least a threshold priority value. And at block 440, location information for the at least the portion of the plurality of terrestrial transceivers is received from the first location server. Here, information regarding the terrestrial transceivers detected during the first period of time (at block 410) is exchanged between the semi-connected mobile device and the first location server. Specifically, the semi-connected mobile device provides the location server with identity information for at least a portion of the plurality of terrestrial transceivers, and the first location server provides a customized tile for the semi-connected mobile device comprising location information (e.g., absolute location such as latitude, longitude, and (optionally) altitude) for the at least the portion of the plurality of terrestrial transceivers. Here, because the list of terrestrial transceivers maintained by the semi-connected mobile device includes priority or “importance” information, information may be sent for only terrestrial transceivers that meet the threshold priority value. Alternatively, a predetermined percentage of terrestrial transceivers having the highest priority values may be sent to the location server.

Means for performing the functionality of blocks 440 and/or 450 can include, for example, processing unit(s) 510, DSP 520, wireless communication interface 530, bus 505, and/or memory 560 of a semi-connected mobile device 105, as illustrated in FIG. 5 and described below.

At block 460, for a second period of time during which the mobile device does not have Internet connectivity over LAN or PAN, one or more of the at least the portion of the plurality of terrestrial transceivers are detected, and a position of the mobile device is determined by using the location information for the one or more of the at least the portion of the plurality of terrestrial transceivers. Here, a semi-connected mobile device can calculate its location using the location information for the one or more terrestrial transceivers by, for example, taking distance and/or angle measurements of the one or more terrestrial transceivers (e.g., using wireless measurements such as RTT, RSSI, AOA, and/or the like), and calculate its location using trilateration, triangulation, and/or similar location-determination means. As indicated previously, the semi-connected mobile device may continue to conduct scans for new and/or previously-detected terrestrial transceivers. For instance, for the second period of time during which the mobile device does not have Internet connectivity over LAN or PAN, the mobile device may detect, using the wireless communication interface, one or more additional terrestrial transceivers and store identity information for the one or more additional terrestrial transceivers in the memory. After the second period of time, the mobile device may further establish a second communication link with a second location server and send the identity information for the one or more terrestrial transceivers to the second location server. (Here, the term “second location server” is meant to show how different location servers may be used in different embodiments. Thus, the “second location server” can be a different server than the first location server, or the same server.) Location information for the one or more additional terrestrial transceivers can then be received from the second location server and stored in the memory of the mobile device.

Means for performing the functionality of block 460 can include, for example, processing unit(s) 510, DSP 520, wireless communication interface 530, bus 505, and/or memory 560 of a semi-connected mobile device 105, as illustrated in FIG. 5 and described below. FIG. 5 illustrates an embodiment of a semi-connected mobile device 105, which can be utilized in the embodiments described herein. It should be noted that FIG. 5 is meant only to provide a generalized illustration of various components, any or all of which may be utilized as appropriate. In other words, because semi-connected mobile devices can vary widely in functionality, they may include only a portion of the components shown in FIG. 5. It can be noted that, in some instances, components illustrated by FIG. 5 can be localized to a single physical device and/or distributed among various networked devices, which may be disposed at different physical locations.

The semi-connected mobile device 105 is shown comprising hardware elements that can be electrically coupled via a bus 505 (or may otherwise be in communication, as appropriate). The hardware elements may include a processing unit(s) 510 which may comprise without limitation one or more general-purpose processors, one or more special-purpose processors (such as digital signal processing (DSP) chips, graphics acceleration processors, application specific integrated circuits (ASICs), and/or the like), and/or other processing structure or means, which can be configured to perform one or more of the methods described herein. As shown in FIG. 5, some embodiments may have a separate DSP 520, depending on desired functionality. The semi-connected mobile device 105 also may comprise one or more input devices 570, which may comprise without limitation one or more touch screens, touch pads, microphones, buttons, dials, switches, and/or the like; and one or more output devices 515, which may comprise without limitation, one or more displays, light emitting diode (LED)s, speakers, and/or the like.

The semi-connected mobile device 105 might also include a wireless communication interface 530, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMax device, cellular communication facilities, etc.), and/or the like. According to some embodiments, the wireless communication interface 530 may further comprise additional hardware (such as a microprocessor or other low-powered processor) to enable low-power wireless scanning, as discussed in the embodiments described above, to detect terrestrial transceivers. The wireless communication interface 530 may permit data (such as the terrestrial transceiver list and/or other information described herein) to be communicated with a network, a location server, wireless access points, other computer systems, and/or any other electronic devices described herein. The communication can be carried out via one or more wireless communication antenna(s) 532 that send and/or receive wireless signals 534.

Depending on desired functionality, the wireless communication interface 530 may comprise separate transceivers to communicate with base transceiver stations and other terrestrial transceivers, such as wireless devices and access points. These different data networks may comprise various network types. Additionally, a WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. A CDMA network may implement one or more radio access technologies (RATs) such as cdma2000, Wideband-CDMA (W-CDMA), and so on. Cdma2000 includes IS-95, IS-2000, and/or IS-856 standards. A TDMA network may implement Global System for Mobile Communications (GSM), Digital Advanced Mobile Phone System (D-AMPS), or some other RAT. An OFDMA network may employ LTE, LTE Advanced, and so on. LTE, LTE Advanced, GSM, and W-CDMA are described in documents from 3GPP. Cdma2000 is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The semi-connected mobile device 105 can further include sensor(s) 540. Such sensors may comprise, without limitation, one or more accelerometer(s), gyroscope(s), camera(s), magnetometer(s), altimeter(s), microphone(s), proximity sensor(s), light sensor(s), and the like. Some or all of the sensor(s) 540 can be utilized, among other things, positioning methods.

Embodiments of the semi-connected mobile device may also include a satellite positioning system (SPS) receiver 580 capable of receiving signals 584 from one or more SPS satellites using an SPS antenna 582. Such positioning can be utilized to complement and/or incorporate the techniques described herein. The SPS receiver 580 can extract a position of the semi-connected mobile device, using conventional techniques, from SPS SVs of an SPS system, such as GNSS (e.g., Global Positioning System (GPS)), Galileo, Glonass, Compass, Quasi-Zenith Satellite System (QZSS) over Japan, Indian Regional Navigational Satellite System (IRNSS) over India, Beidou over China, and/or the like. Moreover, the SPS receiver 580 can be used various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

The semi-connected mobile device 105 may further include and/or be in communication with a memory 560. The memory 560 may comprise, without limitation, local and/or network accessible storage, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like. This memory 560 may be used to store the terrestrial transceiver list described herein, which can be implemented using a database, linked list, or any other type of data structure. Additionally or alternatively, the terrestrial transceiver list may be stored in a separate memory utilized by dedicated hardware for terrestrial transceiver identity collection as described herein. This memory (and dedicated hardware) may be located within the wireless communication interface 530.

The memory 560 of the semi-connected mobile device 105 also can comprise software elements (not shown), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the functionality discussed above might be implemented as code and/or instructions executable by the semi-connected mobile device 105 (and/or a processing unit within a mobile device 105) (and/or another device of a positioning system). In an aspect, then, such code and/or instructions can be used to configure and/or adapt a general purpose computer (or other device) to perform one or more operations in accordance with the described methods.

FIG. 6 illustrates an embodiment of a computer system 600, which may comprise or be incorporated, at least in part, into devices capable of operating as a location server as described herein above. FIG. 6 provides a schematic illustration of one embodiment of a computer system 600 that can perform methods of the previously-described embodiments. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner. In addition, it can be noted that components illustrated by FIG. 6 can be localized to a single device and/or distributed among various networked devices, which may be disposed at different physical locations.

The computer system 600 is shown comprising hardware elements that can be electrically coupled via a bus 605 (or may otherwise be in communication, as appropriate). The hardware elements may include processing unit(s) 610, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 600 also may comprise one or more input devices 615, which may comprise without limitation a mouse, a keyboard, a camera, a microphone, and/or the like; and one or more output devices 620, which may comprise without limitation a display device, a printer, and/or the like.

The computer system 600 may further include (and/or be in communication with) one or more non-transitory storage devices 625, which can comprise, without limitation, local and/or network accessible storage, and/or may comprise, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like. Such data stores may include database(s) and/or other data structures used to gather and store identification and location information of terrestrial transceivers in a coverage area of a location server, as described in the embodiments above.

The computer system 600 might also include a communications subsystem 630, which may comprise wireless communication technologies managed and controlled by a wireless communication interface 633, as well as wired technologies. As such, the communications subsystem may comprise a modem, a network card (wireless or wired), an infrared communication device, a wireless communication device, and/or a chipset (such as a Bluetooth device, an IEEE 802.11 device, an IEEE 802.15.4 device, a Wi-Fi device, a WiMax device, cellular communication facilities, UWB interface, etc.), and/or the like. The communications subsystem 630 may include one or more input and/or output communication interfaces, such as the wireless communication interface 633, to permit data to be exchanged with a network, mobile devices (such as the semi-connected mobile device 105 of FIG. 5), other computer systems, and/or any other electronic devices described herein. Hence, the communications subsystem 630 may be used to receive and send data as described in the embodiments herein.

In many embodiments, the computer system 600 will further comprise a working memory 635, which may comprise a RAM or ROM device, as described above. Software elements, shown as being located within the working memory 635, may comprise an operating system 640, device drivers, executable libraries, and/or other code, such as one or more applications 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processing unit within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 625 described above. In some cases, the storage medium might be incorporated within a computer system, such as computer system 600. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that may comprise memory may comprise non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A mobile device comprising:
communication interface;
a memory; and
a processing unit configured to cause the mobile device to:
during a first period of time during which the mobile device does not have Internet connectivity over a wireless local area network (WLAN), local area network (LAN), or personal area network (PAN), or combination thereof:
wirelessly detect, using the communication interface, a plurality of terrestrial transceivers, and
store identity information for each of the plurality of terrestrial transceivers in the memory;
determine a priority value of each of the plurality of terrestrial transceivers;
after the first period of time and in response to establishing Internet connectivity over WLAN, LAN, PAN, or a combination thereof, establish a first communication link with a first location server;
send, via the communication interface, the identity information for at least a portion of the plurality of terrestrial transceivers to the first location server, wherein the at least the portion of the plurality of terrestrial transceivers comprises terrestrial transceivers having at least a threshold priority value;
receive, from the first location server via the communication interface, location information for the at least the portion of the plurality of terrestrial transceivers.

2. The mobile device of claim 1, wherein the processing unit is configured to:
for a second period of time during which the mobile device does not have the Internet connectivity over WLAN, LAN, PAN, or a combination thereof:
detect, using the communication interface, one or more of the at least the portion of the plurality of terrestrial transceivers; and
determine a position of the mobile device by using the location information for the one or more of the at least the portion of the plurality of terrestrial transceivers.

3. The mobile device of claim 1, wherein the processing unit is configured to cause the mobile device to, for each of the plurality of terrestrial transceivers, determine the priority value of the terrestrial transceiver based on:
a frequency of detection of the terrestrial transceiver,
a number of times that the terrestrial transceiver is detected,
a time of detection of the terrestrial transceiver,
a signal strength of the terrestrial transceiver,
a location of the terrestrial transceiver,
a context of the terrestrial transceiver,
a correlation of observability of the terrestrial transceiver,
an age of detection of the terrestrial transceiver, or
a duration of detection of the terrestrial transceiver, or
any combination thereof.

4. The mobile device of claim 1, wherein the processing unit is configured to cause the mobile device to send the identity information for the plurality of terrestrial transceivers to the first location server based on a determination that the priority value of each of the plurality of terrestrial transceivers meets the threshold priority value.

5. The mobile device of claim 1, wherein the processing unit comprises:
a first processor configured to cause the mobile device to wirelessly detect the plurality of terrestrial transceivers and
a second processor configured to cause the mobile device to send the identity information for the at least the portion of the plurality of terrestrial transceivers to the first location server.

6. The mobile device of claim 1, wherein the processing unit is configured to cause the mobile device to:
for a second period of time during which the mobile device does not have Internet connectivity over WLAN, LAN, PAN, or a combination thereof:
wirelessly detect, using the communication interface, one or more additional terrestrial transceivers, and
store identity information for each of the one or more additional terrestrial transceivers in the memory; and
after the second period of time and in response to establishing Internet connectivity over WLAN, LAN, PAN, or a combination thereof:
establish a second communication link with a second location server; and
send, via the communication interface, the identity information for the one or more additional terrestrial transceivers to the second location server.

7. The mobile device of claim 6, wherein the second location server is a different server than the first location server.

8. The mobile device of claim 6, wherein the processing unit is further configured to cause the mobile device to:
receive, from the second location server, location information for the one or more additional terrestrial transceivers, and
store the location information for the one or more additional terrestrial transceivers in the memory.

9. The mobile device of claim 1, wherein the processing unit is configured to cause the mobile device to increase a rate at which the mobile device conducts scans for terrestrial transceivers in response to determining that the mobile device is moving.

10. A method of managing terrestrial transceiver positioning downloads by a mobile device, the method comprising:
during a first period of time during which the mobile device does not have Internet connectivity over a wireless local area network (WLAN), local area network (LAN), or personal area network (PAN), or combination thereof:
wirelessly detecting a plurality of terrestrial transceivers using a communication interface of the mobile device, and
storing identity information for each of the plurality of terrestrial transceivers in a memory of the mobile device;
determining a priority value of each of the plurality of terrestrial transceivers;
after the first period of time and in response to the mobile device establishing Internet connectivity over WLAN, LAN, PAN, or a combination thereof, establishing, via the communication interface of the mobile device, a first communication link between the mobile device and a first location server;
sending, via the communication interface of the mobile device, the identity information for at least a portion of the plurality of terrestrial transceivers to the first location server, wherein the at least the portion of the plurality of terrestrial transceivers comprises terrestrial transceivers having at least a threshold priority value;
receiving, via the communication interface of the mobile device, location information for the at least the portion of the plurality of terrestrial transceivers.

11. The method of claim 10, further comprising, for a second period of time during which the mobile device does not have the Internet connectivity over WLAN, LAN, PAN, or a combination thereof:
detecting, using the communication interface of the mobile device, one or more of the at least the portion of the plurality of terrestrial transceivers; and
determining, using a processor of the mobile device, a position of the mobile device by using the location information for the one or more of the at least the portion of the plurality of terrestrial transceivers.

12. The method of claim 10, further comprising, for each of the plurality of terrestrial transceivers, determining the priority value of the terrestrial transceiver based on:
a frequency of detection of the terrestrial transceiver,
a number of times that the terrestrial transceiver is detected,
a time of detection of the terrestrial transceiver,
a signal strength of the terrestrial transceiver,
a location of the terrestrial transceiver,
a context of the terrestrial transceiver,
a correlation of observability of the terrestrial transceiver,
an age of detection of the terrestrial transceiver, or
a duration of detection of the terrestrial transceiver, or
any combination thereof.

13. The method of claim 10, wherein sending the identity information for the plurality of terrestrial transceivers to the first location server based on a determination that the priority value of each of the plurality of terrestrial transceivers meets the threshold priority value.

14. The method of claim 10, further comprising:
using a first processor of the mobile device to wirelessly detect the plurality of terrestrial transceivers and
using a second processor of the mobile device to send the identity information for the at least the portion of the plurality of terrestrial transceivers to the first location server.

15. The method of claim 10, further comprising:
for a second period of time during which the mobile device does not have Internet connectivity over WLAN, LAN, PAN, or a combination thereof:
wirelessly detecting, using the communication interface of the mobile device, one or more additional terrestrial transceivers, and
storing identity information for each of the one or more additional terrestrial transceivers in the memory of the mobile device; and
after the second period of time and in response to establishing Internet connectivity over WLAN, LAN, PAN, or a combination thereof:
establishing, via the communication interface of the mobile device, a second communication link with a second location server; and
sending, via the communication interface of the mobile device, the identity information for the one or more additional terrestrial transceivers to the second location server.

16. The method of claim 15, further comprising:
receiving, by the mobile device from the second location server, location information for the one or more additional terrestrial transceivers, and
storing the location information for the one or more additional terrestrial transceivers in the memory of the mobile device.

17. The method of claim 10, further comprising, in response to determining that the mobile device is moving, increasing a rate at which the mobile device conducts scans for terrestrial transceivers.

18. An apparatus comprising:
means for, during a first period of time during which the apparatus does not have Internet connectivity over a wireless local area network (WLAN), local area network (LAN), or personal area network (PAN), or combination thereof:
wirelessly detecting a plurality of terrestrial transceivers, and
storing identity information for each of the plurality of terrestrial transceivers;
means for determining a priority value of each of the plurality of terrestrial transceivers;
means for, after the first period of time and in response to establishing Internet connectivity over WLAN, LAN, PAN, or a combination thereof, establishing a first communication link between with a first location server;
means for sending the identity information for at least a portion of the plurality of terrestrial transceivers to the first location server, wherein the at least the portion of the plurality of terrestrial transceivers comprises terrestrial transceivers having at least a threshold priority value;
means for receiving location information for the at least the portion of the plurality of terrestrial transceivers.

19. The apparatus of claim 18, further comprising means for, for a second period of time during which the apparatus does not have the Internet connectivity over WLAN, LAN, PAN, or a combination thereof:
detecting one or more of the at least the portion of the plurality of terrestrial transceivers; and
determining a position of the apparatus by using the location information for the one or more of the at least the portion of the plurality of terrestrial transceivers.

20. The apparatus of claim 18, further comprising, for each of the plurality of terrestrial transceivers, means for determining the priority value of the terrestrial transceiver based on:
a frequency of detection of the terrestrial transceiver,
a number of times that the terrestrial transceiver is detected,
a time of detection of the terrestrial transceiver,
a signal strength of the terrestrial transceiver,
a location of the terrestrial transceiver,
a context of the terrestrial transceiver,
a correlation of observability of the terrestrial transceiver,
an age of detection of the terrestrial transceiver, or
a duration of detection of the terrestrial transceiver, or
any combination thereof.

21. The apparatus of claim 18, wherein the means for sending the identity information for the plurality of terrestrial transceivers to the first location server is based on a determination that the priority value of each of the plurality of terrestrial transceivers meets the threshold priority value.

22. The apparatus of claim 18, further comprising:
first processing means configured cause the apparatus to wirelessly detect the plurality of terrestrial transceivers and
second processing means configured cause the apparatus send the identity information for the at least the portion of the plurality of terrestrial transceivers to the first location server.

23. The apparatus of claim 18, further comprising:
means for, for a second period of time during which the apparatus does not have Internet connectivity over WLAN, LAN, PAN, or a combination thereof:
wirelessly detecting one or more additional terrestrial transceivers, and
storing identity information for each of the one or more additional terrestrial transceivers; and
means for, after the second period of time and in response to establishing Internet connectivity over WLAN, LAN, PAN, or a combination thereof:
establishing a second communication link with a second location server; and
sending the identity information for the one or more additional terrestrial transceivers to the second location server.

24. The apparatus of claim 23, further comprising:
means for receiving, from the second location server, location information for the one or more additional terrestrial transceivers, and
means for storing the location information for the one or more additional terrestrial transceivers.

25. The apparatus of claim 18, further comprising means for, in response to determining that the apparatus is moving, increasing a rate at which the apparatus conducts scans for terrestrial transceivers.

26. A non-transitory computer-readable medium having instructions embedded thereon for managing terrestrial transceiver positioning downloads by a mobile device, the instructions including computer code for:
during a first period of time during which the mobile device does not have Internet connectivity over a wireless local area network (WLAN), local area network (LAN), or personal area network (PAN), or combination thereof:
wirelessly detecting a plurality of terrestrial transceivers, and
storing identity information for each of the plurality of terrestrial transceivers;
determining a priority value of each of the plurality of terrestrial transceivers;
after the first period of time and in response to the mobile device establishing Internet connectivity over WLAN, LAN, PAN, or a combination thereof, establishing a first communication link between the mobile device and a first location server;
sending the identity information for at least a portion of the plurality of terrestrial transceivers to the first location server, wherein the at least the portion of the plurality of terrestrial transceivers comprises terrestrial transceivers having at least a threshold priority value;
receiving location information for the at least the portion of the plurality of terrestrial transceivers.

27. The non-transitory computer-readable medium of claim 26, further comprising computer code for, for a second period of time during which the mobile device does not have the Internet connectivity over WLAN, LAN, PAN, or a combination thereof:
detecting, using the communication interface of the mobile device, one or more of the at least the portion of the plurality of terrestrial transceivers; and
determining, using a processor of the mobile device, a position of the mobile device by using the location information for the one or more of the at least the portion of the plurality of terrestrial transceivers.

28. The non-transitory computer-readable medium of claim 26, further comprising, computer code for, for each of the plurality of terrestrial transceivers, determining the priority value of the terrestrial transceiver based on:
a frequency of detection of the terrestrial transceiver,
a number of times that the terrestrial transceiver is detected,
a time of detection of the terrestrial transceiver,
a signal strength of the terrestrial transceiver,
a location of the terrestrial transceiver,
a context of the terrestrial transceiver,
a correlation of observability of the terrestrial transceiver,
an age of detection of the terrestrial transceiver, or
a duration of detection of the terrestrial transceiver, or
any combination thereof.

29. The non-transitory computer-readable medium of claim 26, further comprising computer code for:
using a first processor of the mobile device to wirelessly detect the plurality of terrestrial transceivers and
using a second processor of the mobile device to send the identity information for the at least the portion of the plurality of terrestrial transceivers to the first location server.

30. The method of claim 26, further comprising computer code for:
for a second period of time during which the mobile device does not have Internet connectivity over WLAN, LAN, PAN, or a combination thereof:
wirelessly detecting one or more additional terrestrial transceivers, and
storing identity information for each of the one or more additional terrestrial transceivers; and
after the second period of time and in response to establishing Internet connectivity over WLAN, LAN, PAN, or a combination thereof:
establishing a second communication link with a second location server; and
sending the identity information for the one or more additional terrestrial transceivers to the second location server.
